(19) United States
(12) Patent Application Publication
(10) Pub. No.: US 2023/0247232 A1
(43) Pub. Date: Aug. 3, 2023

(54) METHODS, APPARATUSES AND COMPUTER PROGRAM PRODUCTS FOR ENABLING LIVE STREAMING FROM MULTIPLE CAMERAS

(71) Applicant: META PLATFORMS, INC., Menlo Park, CA (US)

(72) Inventor: Clifford Neil Didcock, Bainbridge Island, WA (US)

(21) Appl. No.: 18/061,078

(22) Filed: Dec. 2, 2022

Related U.S. Application Data
(60) Provisional application No. 63/306,241, filed on Feb. 3, 2022.

(51) Int. Cl. H04N 21/2187; H04N 21/218

(52) U.S. Cl. CPC H04N 21/2187; H04N 21/21805

(57) ABSTRACT

A system for providing multiple videos captured simultaneously from different cameras to enable streaming of the multiple videos to one or more communication devices is disclosed. The system may receive first video content captured by a first camera associated with a communication device. The first video content may include video indicia associated with a view of a scene that a user views while looking at an environment associated with the scene. The system may also receive second video content captured by a second camera associated with the communication device. The second video content may include video data indicating at least the user. The first video content and the second video content may be captured simultaneously by the first camera and the second camera. The system may also configure the first video content captured by the first camera and the second video content captured by the second camera to be presented to one or more display devices of one or more communication devices associated with one or more users.

### CROSS-REFERENCE TO RELATED APPLICATIONS

This application claims the benefit of U.S. Provisional Application No. 63/306,241 filed Feb. 3, 2022, entitled “Methods, Apparatuses And Computer Program Products For Enabling Live Streaming From Multiple Cameras,” the entire content of which is incorporated herein by reference.

### TECHNOLOGICAL FIELD

Exemplary embodiments of this disclosure relate generally to methods, apparatuses and computer program products for enabling live video streaming based on video content captured by multiple cameras.

### BACKGROUND

Some existing mobile devices may record content from multiple on-device cameras concurrently. Although these existing mobile devices may utilize concurrent camera capability to record content from multiple cameras, they typically only output/stream a single video from only one of the cameras with a specific video design. In this regard, viewers of the resulting video stream may only view and hear the same single composited video from one of the cameras. However, it may be beneficial to provide more flexible video streaming composition capabilities to enhance user experience.

### BRIEF SUMMARY

Exemplary embodiments are described for enabling communication devices to capture video content (e.g., simultaneously/concurrently) from multiple cameras of a communication device and may enable sending of the video content captured by the multiple cameras to a network device. The network device may stream/provide the video content captured by the multiple cameras of the communication device to other communication devices of users.

In some exemplary embodiments, the users of the communication devices may have a social network connection with a user of the communication device having the multiple cameras that captured the video content. The communication devices being streamed the video content captured by the multiple cameras may also be presented with different control options for viewing the video content being streamed. By presenting different control options to the communication devices, users associated with these communication devices may determine/choose the manner in which they desire to view, and listen to, the streamed video. In this manner, different users viewing the same streamed video may have entirely different viewing experiences.

Some control options for example may include, but are not limited to, selecting to view a stream from one of the multiple cameras, selecting to view the streamed video from each of the multiple cameras and selecting to display the streamed video from each of the multiple cameras side-by-side (e.g., 50:50 ratio, a split-screen presentation format), or in a picture-in-picture (PiP) manner.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings exemplary embodiments of the disclosed subject matter; however, the disclosed subject matter is not limited to the specific methods, compositions, and devices disclosed. In addition, the drawings are not necessarily drawn to scale. In the drawings:

FIG. 1 is a diagram of an exemplary network environment in accordance with an exemplary embodiment.

FIG. 2 is a diagram of an exemplary communication device in accordance with an exemplary embodiment.

FIG. 3 is a diagram of an exemplary computing system in accordance with an exemplary embodiment.

FIG. 4A is a diagram illustrating multiple video streams captured by multiple cameras for streaming to one or more users and for display in a side-by-side manner in accordance with an exemplary embodiment.

FIG. 4B is a diagram illustrating multiple video streams captured by multiple cameras for streaming to one or more users and for display in a picture-in-picture manner in accordance with an exemplary embodiment.

FIG. 5 is a diagram of an exemplary process for providing multiple videos captured simultaneously from different cameras to enable streaming of the multiple videos to one or more communication devices in accordance with an exemplary embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the invention. Moreover, the term “exemplary”, as used herein, is not provided to convey any qualitative assessment, but instead merely to convey an illustration of an example. Thus, use of any such terms should not be taken to limit the spirit and scope of embodiments of the invention.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

It is to be understood that the methods and systems described herein are not limited to specific methods, specific components, or to particular implementations. It is also to be understood that the terminology used herein is for the purpose of describing particular embodiments only and is not intended to be limiting.

### Exemplary System Architecture

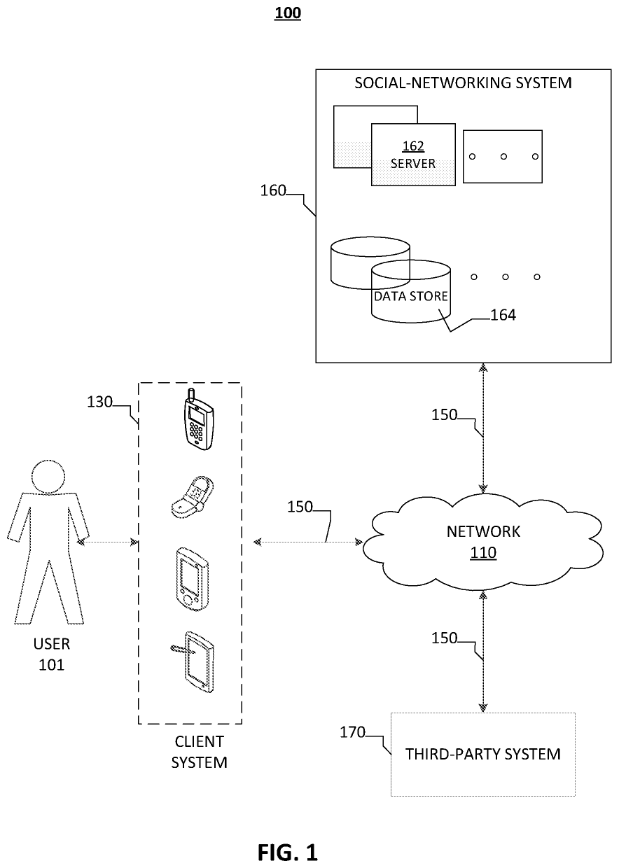

FIG. 1 illustrates an example network environment 100 associated with a social-networking system 160 (also referred to herein as network device 160). Network environment 100 includes a user 101, a client system 130, a social-networking system 160, and a third-party system 170 connected to each other by a network 110. Although FIG. 1 illustrates a particular arrangement of user 101, client system 130, social-networking system 160, third-party system 170, and network 110, this disclosure contemplates any suitable arrangement of user 101, client system 130, social-networking system 160, third-party system 170, and network 110. As an example and not by way of limitation, two or more of client system 130, social-networking system 160, and third-party system 170 may be connected to each other directly, bypassing network 110. As another example, two or more of client system 130, social-networking system 160, and third-party system 170 may be physically or logically co-located with each other in whole or in part. Moreover, although FIG. 1 illustrates a particular number of users 101, client systems 130, social-networking systems 160, third-party systems 170, and networks 110, this disclosure contemplates any suitable number of users 101, client systems 130, social-networking systems 160, third-party systems 170, and networks 110. As an example and not by way of limitation, network environment 100 may include multiple client systems 130, social-networking systems 160, third-party systems 170, and networks 110.

In particular embodiments, user 101 may be an individual (human user), an entity (e.g., an enterprise, business, or third-party application), or a group (e.g., of individuals or entities) that interacts or communicates with or over social-networking system 160. In particular embodiments, one or more users 101 may use one or more client systems 130 to access, send data to, and receive data from social-networking system 160 or third-party system 170.

This disclosure contemplates any suitable network 110. As an example and not by way of limitation, one or more portions of network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 110 may include one or more networks 110.

Links 150 may connect client system 130, social-networking system 160, and third-party system 170 to communication network 110 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout network environment 100. One or more first links 150 may differ in one or more respects from one or more second links 150.

In particular embodiments, client system 130 may be an electronic device including hardware, software, or embedded logic components or a combination of two or more such components and capable of carrying out the appropriate functionalities implemented or supported by client system 130. As an example and not by way of limitation, a client system 130 may include a computer system such as a desktop computer, notebook or laptop computer, netbook, a tablet computer, e-book reader, global positioning system (GPS) device, camera, personal digital assistant (PDA), handheld electronic device, cellular telephone, smartphone, augmented/virtual reality device, other suitable electronic device, or any suitable combination thereof. This disclosure contemplates any suitable client systems 130. A client system 130 may enable user 101 to access network 110. A client system 130 may enable its user 101 to communicate with other users 101 at other client systems 130.

In particular embodiments, social-networking system 160 may be a network-addressable computing system that can host an online social network. Social-networking system 160 may generate, store, receive, and send social-networking data, such as, for example, user-profile data, concept-profile data, social-graph information, or other suitable data related to the online social network. Social-networking system 160 may be accessed by the other components of network environment 100 either directly or via network 110. As an example and not by way of limitation, client system 130 may access social-networking system 160 using a web browser or a native application associated with social-networking system 160 (e.g., a mobile social-networking application, a messaging application, another suitable application, or any combination thereof) either directly or via network 110. In particular embodiments, social- networking system 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 162 may include hardware, software, or embedded logic components or a combination of two or more such components for carrying out the appropriate functionalities implemented or supported by server 162. In particular embodiments, social-networking system 160 may include one or more data stores 164. Data stores 164 may be used to store various types of information. In particular embodiments, the information stored in data stores 164 may be organized according to specific data structures. In particular embodiments, each data store 164 may be a relational, columnar, correlation, or other suitable database. Although this disclosure describes or illustrates particular types of databases, this disclosure contemplates any suitable types of databases. Particular embodiments may provide interfaces that enable a client system 130, a social-networking system 160, or a third-party system 170 to manage, retrieve, modify, add, or delete, the information stored in data store 164.

In particular embodiments, social-networking system 160 may store one or more social graphs (e.g., social graph 300) in one or more data stores 164. In particular embodiments, a social graph may include multiple nodes—which may include multiple user nodes (each corresponding to a particular user 101) or multiple concept nodes (each corresponding to a particular concept)—and multiple edges connecting the nodes. Social-networking system 160 may provide users 101 of the online social network the ability to communicate and interact with other users 101. In particular embodiments, users 101 may join the online social network via social-networking system 160 and then add connections (e.g., relationships) to a number of other users 101 of social-networking system 160 to whom they want to be connected. Herein, the term “friend” may refer to any other user 101 of social-networking system 160 with whom a user 101 has formed a connection, association, or relationship via social-networking system 160.

In particular embodiments, social-networking system 160 may provide users 101 with the ability to take actions on various types of items or objects, supported by social-networking system 160. As an example and not by way of limitation, the items and objects may include groups or social networks to which users of social-networking system 160 may belong, events or calendar entries in which a user might be interested, computer-based applications that a user may use, transactions that allow users to buy or sell items via the service, interactions with images/videos, interactions with advertisements that a user may perform, or other suitable items or objects. A user may interact with anything that is capable of being represented in social-networking system 160 or by an external system of third-party system 170, which is separate from social-networking system 160 and coupled to social-networking system 160 via a network 110.

In particular embodiments, social-networking system 160 may be capable of linking a variety of entities. As an example and not by way of limitation, social-networking system 160 may enable users to interact with each other as well as receive content from third-party systems 170 or other entities, or to allow users to interact with these entities through an application programming interfaces (API) or other communication channels.

In particular embodiments, social-networking system 160 also includes user-generated content objects, which may enhance a user's interactions with social-networking system 160. User-generated content may include any data a user (e.g., user 101) may add, upload, send, or “post” that is publicly (e.g., not private) available to social-networking system 160. As an example and not by way of limitation, a user may communicate public posts to social-networking system 160 from a client system 130. Public posts may include data such as status updates or other textual data, location information, photos, videos, audio, links, music or other similar data or media that is publicly available to social-networking-system 160. Content may also be added to social-networking system 160 by a third-party through a “communication channel,” such as a newsfeed or stream.

### Exemplary Communication Device

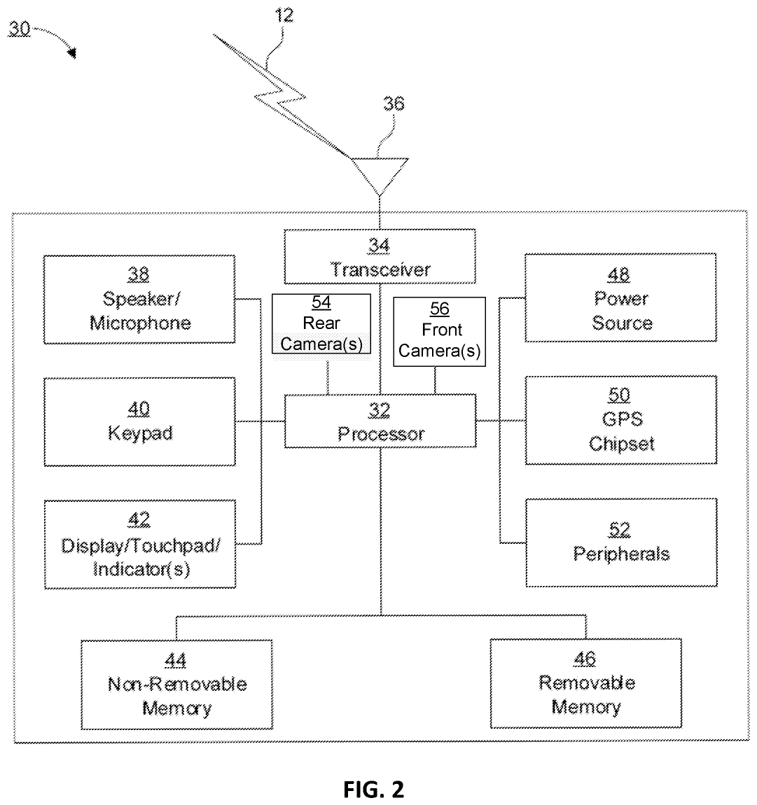

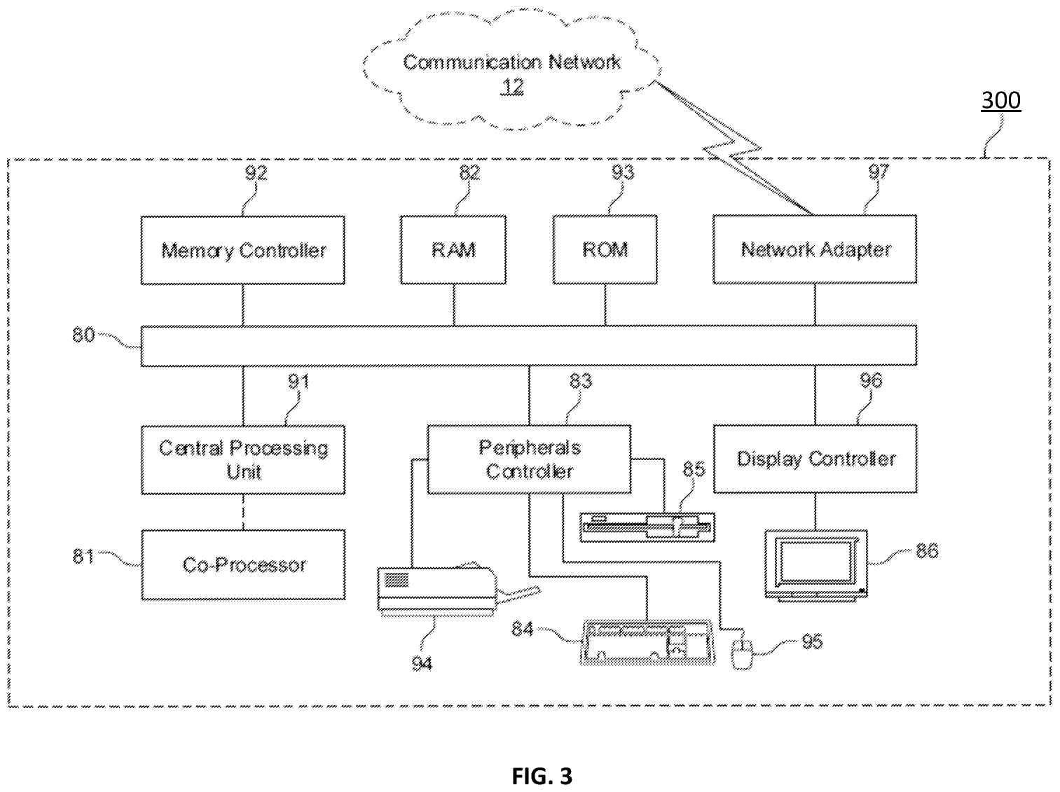

FIG. 2 illustrates a block diagram of an exemplary hardware/software architecture of a communication device such as, for example, user equipment (UE) 30. In some exemplary embodiments, the UE 30 may be any of client devices 130. In some exemplary embodiments, the UE 30 may be a computer system such as for example a cellular telephone, a smartphone, a desktop computer, notebook or laptop computer, netbook, a tablet computer (e.g., a smart tablet), e-book reader, global positioning system (GPS) device, camera, personal digital assistant, handheld electronic device, smart glasses, augmented/virtual reality device, smart watch, or any other suitable electronic device. As shown in FIG. 2, the UE 30 (also referred to herein as node 30) may include a processor 32, non-removable memory 44, removable memory 46, a speaker/microphone 38, a keypad 40, a display, touchpad, and/or indicators 42, a power source 48, a GPS chipset 50, and other peripherals 52. The power source 48 may be capable of receiving electric power for supplying electric power to the UE 30. For example, the power source 48 may include an alternating current to direct current (AC-to-DC) converter allowing the power source 48 to be connected/plugged to an AC electrical receptable and/or Universal Serial Bus (USB) port for receiving electric power. The UE 30 may also include one or more inward facing cameras 54 and one or more outward facing cameras 56. In an exemplary embodiment, the inward facing cameras 54 (also referred to herein as rear camera(s) 54) and outward facing cameras 56 (also referred to herein as front camera(s) 56) may be smart cameras configured to sense images/videos appearing within one or more bounding boxes. The one or more inward-facing cameras 54 may capture one or more images/videos (e.g., selfie images/videos) of a user(s) (e.g., user 101) and/or objects in the background associated with the user(s). The one or more outward facing cameras 56 may capture one or more images/videos indicative of a scene (e.g., from a viewpoint of a user). In other words, the one or more outward facing cameras 56 may identify/capture the scene or view which the user sees. Furthermore, in addition to capturing the scene, the one or more outward facing cameras 56 may capture an image(s)/video(s) of a hand(s), device(s), or other object(s) or movement(s) indicative of a gesture in the field of view of the scene. In some exemplary embodiments, the one or more inward facing cameras 54 and the one or more outward facing cameras may capture content (e.g., images/videos) simultaneously/concurrently and may provide the simultaneously/concurrently captured content to a network device (e.g., network device 160 of FIG. 1, computing system 300 of FIG. 3). The network device may stream the captured video content to one or more devices of users and/or may store the captured video content for subsequent viewing (e.g., video on demand) by the one or more users. The UE 30 may also include communication circuitry, such as a transceiver 34 and a transmit/receive element 36. It will be appreciated the UE 30 may include any sub-combination of the foregoing elements while remaining consistent with an embodiment.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., memory 44 and/or memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

The processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an exemplary embodiment, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another exemplary embodiment, the transmit/receive element 36 may be configured to transmit and/or receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other exemplary embodiments, the processor 32 may access information from, and store data in, memory that is not physically located on the node 30, such as on a server or a home computer.

The processor 32 may receive power from the power source 48, and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like. The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an exemplary embodiment.

### Exemplary Computing System

FIG. 3 is a block diagram of an exemplary computing system 300. In some exemplary embodiments, the network device 160 may be a computing system 300. The computing system 300 may comprise a computer or server and may be controlled primarily by computer readable instructions, which may be in the form of software, wherever, or by whatever means such software is stored or accessed. Such computer readable instructions may be executed within a processor, such as central processing unit (CPU) 91, to cause computing system 300 to operate. In many workstations, servers, and personal computers, central processing unit 91 may be implemented by a single-chip CPU called a microprocessor. In other machines, the central processing unit 91 may comprise multiple processors. Coprocessor 81 may be an optional processor, distinct from main CPU 91, that performs additional functions or assists CPU 91.

In operation, CPU 91 fetches, decodes, and executes instructions, and transfers information to and from other resources via the computer's main data-transfer path, system bus 80. Such a system bus connects the components in computing system 300 and defines the medium for data exchange. System bus 80 typically includes data lines for sending data, address lines for sending addresses, and control lines for sending interrupts and for operating the system bus. An example of such a system bus 80 is the Peripheral Component Interconnect (PCI) bus.

Memories coupled to system bus 80 include RAM 82 and ROM 93. Such memories may include circuitry that allows information to be stored and retrieved. ROMs 93 generally contain stored data that cannot easily be modified. Data stored in RAM 82 may be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 300 may contain peripherals controller 83 responsible for communicating instructions from CPU 91 to peripherals, such as printer 94, keyboard 84, mouse 95, and disk drive 85.

Display 86, which is controlled by display controller 96, is used to display visual output generated by computing system 300. Such visual output may include text, graphics, animated graphics, and video. Display 86 may be implemented with a cathode-ray tube (CRT)-based video display, a liquid-crystal display (LCD)-based flat-panel display, gas plasma-based flat-panel display, or a touch-panel. Display controller 96 includes electronic components required to generate a video signal that is sent to display 86.

Further, computing system 300 may contain communication circuitry, such as for example a network adaptor 97, that may be used to connect computing system 300 to an external communications network, such as network 12 of FIG. 2, to enable the computing system 300 to communicate with other nodes (e.g., UE 30) of the network.

### Exemplary System Operation

Exemplary embodiments are described for enabling communication devices to capture video content (e.g., simultaneously/concurrently) from multiple cameras of a communication device and may enable sending of the video content captured by the multiple cameras to a network device. The network device may stream/provide the video content captured by the multiple cameras of a communication device to other communication devices of users.

For instance, for purposes of illustration and not of limitation, consider an example in which a user A is utilizing a communication device (e.g., UE 30, client system 130) having multiple cameras (e.g., rear camera(s) 54, front camera(s) 56) to capture multiple content items (e.g., videos) of interest. In this example, consider that the user A has traveled to Paris and is utilizing a first camera (e.g., front camera(s) 56) of the communication device to capture video of a scene of the Eiffel Tower. Additionally, the user A may utilize a second camera (e.g., rear camera(s) 54) of the communication device to capture video content of himself/herself (i.e., of the same scene associated with the Eiffel Tower) such as for example in a selfie video. The communication device of user A may (e.g., simultaneously) provide both the video of the Eiffel Tower and the selfie video to a network device (e.g., network device 160). In this manner, the network device may provide both the video of the Eiffel Tower and the selfie video to one or more communication devices of other users. These other users for example may, but need not, be social network connections (e.g., friends) with the user A that captured the video of the Eiffel Tower and the selfie video.

In some instances, the network device may provide both the video of the Eiffel Tower and the selfie video to the communication devices of the other users simultaneously. In this manner, the other users may be able to view user A walking around Paris capturing content of the Eiffel Tower to stream, which may, for example, be presented in a top left-hand corner of a display device (or other area of the display device) and may view the selfie video in a bigger/fuller portion of the display device (e.g., in a picture-in-picture manner).

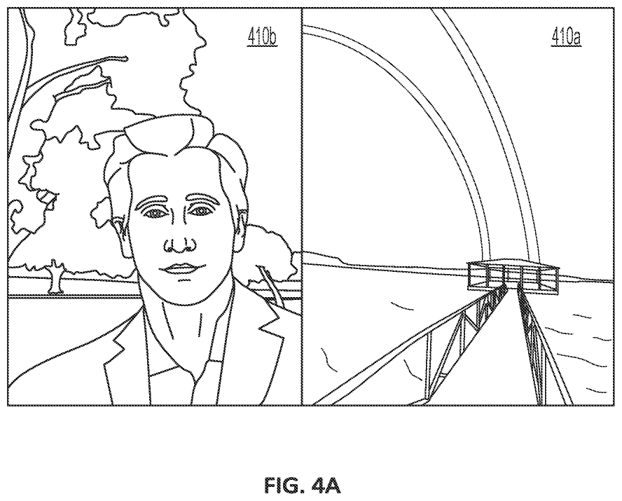

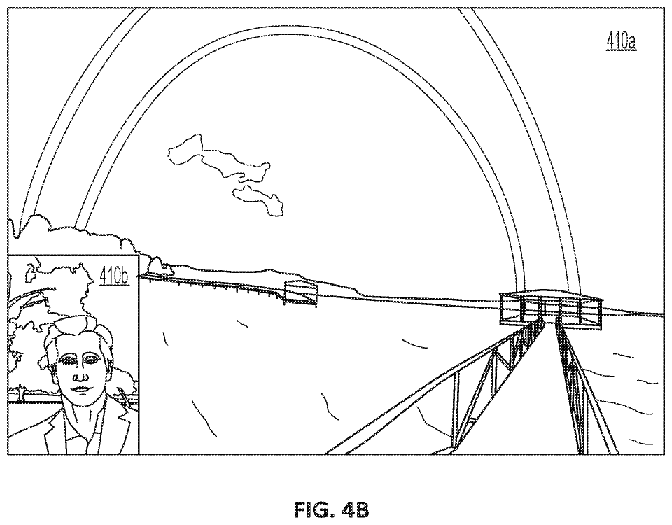

Referring now to FIG. 4A, a diagram illustrating multiple video streams captured by multiple cameras for streaming to one or more users and for display in a side-by-side manner is provided according to an exemplary embodiment. In the example of FIG. 4A, consider that a user A is utilizing a communication device (e.g., UE 30, client system 130) having multiple cameras (e.g., rear camera(s) 54, front camera(s) 56) to capture multiple content items (e.g., videos) of interest. In this example, consider that the user A is visiting an area associated with a lake with a rainbow in the background and is utilizing a first camera (e.g., front camera(s) 56) of the communication device to capture video of a scene 410a of the lake and the rainbow (and other objects). In addition, the user A may utilize a second camera (e.g., rear camera(s) 54) of the communication device to capture video content of himself/herself (i.e., of the same scene associated with the lake and the rainbow) such as for example in a selfie video 410b. The communication device of user A may (e.g., simultaneously) provide both the video 410a of the rainbow and the lake and the selfie video 410b to a network device (e.g., network device 160). In this regard, the network device may provide both the video 410a of the lake and the rainbow and the selfie video 410b of the user A to one or more communication devices of other users. These other users for example may, but need not, be social network connections (e.g., friends) with the user A that captured the video 410a of the lake and the rainbow and the selfie video 410b.

In some instances, the network device may provide both the video 410a of the lake and the rainbow and the selfie video 410b to the communication devices of the other users simultaneously. As such, the other users may be able to view (e.g., in real-time) user A capturing content of the lake and the rainbow to stream as well as user A capturing content of himself and the associated background. In this example, the other users may be presented control options via their communications devices (e.g., UEs 30, client systems 130) by the network device (e.g., network device 160) to choose the manner in which they desire the two video streams (e.g., video 410a, video 410b) to be presented via the display devices (e.g., display 42) of their communication devices. In the example of FIG. 4A, consider that at least one of the users such as for example user B of the set of other users chose to have the lake and rainbow video 410a and the selfie video 410b be presented by the network device to the display device (e.g., display 42) of their communication device (e.g., UE 30, client system 130) in a side-by-side manner (e.g., a 50:50 ratio manner) as shown in FIG. 4A.

Referring now to FIG. 4B, a diagram illustrating multiple video streams captured by multiple cameras for streaming to one or more users and for display in a picture-in-picture manner is provided according to an exemplary embodiment. In the example of FIG. 4B, consider that at least one of the users such as, for example, user C of the set of other users described above (e.g., in FIG. 4A) chose to have the lake and rainbow video 410a and the selfie video 410b be presented by the network device to the display device (e.g., display 42) of their communication device (e.g., UE 30, client system 130) in a picture-in-picture manner, as shown in FIG. 4B. Similar to the example above, regarding FIG. 4A, the network device (e.g., network device 160) may have presented user C one or more control options for user C to choose the manner in which user C desired the two video streams (e.g., video 410a, video 410b) to be presented via the display devices (e.g., display 42) of the communication device associated with user C. Consider that in this example of FIG. 4B, user C selected a control option presented to the display device by the network device to view the two video streams (e.g., video 410a, video 410b) in a picture-in-picture manner, as shown in FIG. 4B. In the example of FIG. 4B, the display device may display the video 410a associated with the lake and the rainbow in a larger portion of the screen of the display device and the selfie video 410b in a smaller portion of the screen of the display device in the picture-in-picture manner. However, in other examples, the user C may have chosen from the control options, provided to the display device by the network device, to have the video 410a associated with the lake and the rainbow in the smaller portion of the screen of the display device and the selfie video 410b in the larger portion of the screen of the display device in the picture-in-picture manner.

FIGS. 4A and 4B also illustrate that the other users (e.g., user B, user C) being presented the two videos (e.g., video 410a, video 410b) by the network device may choose control options to view the same two video streams being presented to their display devices differently from each other.

In some other exemplary embodiments, the network device (e.g., network device 160) may consider the network bandwidth associated with users that may be presented two or more video streams. For instance, in the Paris example above involving the Eiffel Tower, the user A may be walking around Paris with a communication device on a cellular network and as such sending multiple video streams over the cellular network may be a challenge in some instances due to network bandwidth constraints for example (e.g., huge cellular network traffic). In this regard, the network device may present one of the videos in a high-quality manner (e.g., 1080p) and may present the other video in a lower quality manner (e.g., less than 1080p). In an example embodiment, the network device may determine that a selfie video (e.g., video 410b) may not require as much resolution quality as the video of a scene (e.g., the video of the Eiffel tower or the video 410a of the lake and rainbow) since the selfie video may be mainly capturing the video of a close-up view of a user's face. As such, based on considering the network conditions (e.g., cellular network conditions), the network device in some instances may determine to send to one or more communication devices of users a selfie video (e.g., selfie video 410b) in a lower resolution for example as a small video in a picture-in-picture display and to send to the one or more communication devices of the users the video of the scene (e.g., video 410a) in a larger resolution and/or bigger video in the same picture-in-picture display.

In other exemplary embodiments, the network device may determine based on considering the network conditions (e.g., cellular network conditions), to send to the one or more communication devices of users the video of the scene (e.g., video 410a) in a lower resolution for example as a small video in a picture-in-picture display and to send to the one or more communication devices of the users the video of the selfie video (e.g., selfie video 410b) in a larger resolution and/or bigger video in the same picture-in-picture display. In some exemplary embodiments, the network device may present to the corresponding communication devices one or more control options for the users to select which of the two videos to present in the larger resolution and the smaller resolution prior to actually presenting the two videos to the display devices of the communication devices.

In other alternative exemplary embodiments, the network device may determine (for example based on network conditions, etc.) that it may not be advisable to send two video streams to communication devices of one or more users because the network quality may be less than optimal to support sending two quality video streams. In this regard, as an example for purposes of illustration and not of limitation, the network device may determine that a communication device associated with user D is experiencing network congestion and may determine to select one video (e.g., video 410a) of the two video streams (e.g., video 410a, video 410b) to present to the display device of the communication device of user D in real-time. In this regard, the network device may store (e.g., in RAM 82) both of the two video streams on demand (e.g., video on demand (VOD), digital video recorder (DVR)) for example such that the user D is able to view the two video streams later, for example once network conditions are better (e.g., less congested) and/or once the communication device is connected to another network which may not be experiencing network congestion (e.g., a WiFi network, etc.)

In this example embodiment in which initial network conditions may be less than optimal, the network device may not present to a user (e.g., user D) experiencing network degradation any control options since the network device may only present one video stream of the two video streams to the communication device of the user and since the network device may store (e.g., in RAM 82) both of the two video streams for accessing later by the user (e.g., user D).

Some other exemplary embodiments may facilitate associating of multiple video streams with a single same event. For purposes of illustration and not of limitation, consider an instance in which at least two users such as user G and user H are both in-person watching a same soccer game from different sections in a stadium. Consider that user G is at one section behind a goal zone in the field of play and there is a goal (e.g., referred to herein as goal A) scored near user G's section and that video of the goal may be captured by a camera (e.g., front camera(s) 56) of a communication device associated with user G. Consider also that user H is at another section behind another goal zone in the field of play that is opposite to the section of user G and that there is a goal (e.g., also referred to herein as goal B) scored at user H's section and that video of this goal may be captured by a camera (e.g., front camera(s) 56) of a communication device associated with user H. The vantage point of user G's communication device capturing the goal A scored at near his/her section may be better than the vantage point that user H has at the opposite section in the stadium. Similarly, the vantage point of user H′s communication device capturing the goal B scored at near his/her section may be better than the vantage point that user G has at the opposite section in the stadium.

Since user G's view may be better for viewing goal A and user H's view may be better for viewing goal B, it may be beneficial to provide users interested in seeing videos associated with the same soccer game, in this example, a mechanism to view both video streams captured by different cameras of the different communication devices (e.g., the communication device associated with user G, the communication device associated with user H). In this regard, in an instance in which both captured video streams are provided to the network device, the network device may associate the two video streams with a same event (e.g., the soccer game), by posting the two videos to a page (e.g., a webpage). The users G and H may have a level of permission (e.g., administration (admin) rights) authorizing the users G and H rights to the page in which other users such as for example user I, user J, and user K with the same level of rights (e.g., admin rights) to the page are also able to access the page. As such, one or more of the users I, J, K having access to the page may choose the videos they wish to view that are associated with the same event (for instance, the soccer game in this example). In this example, the two video streams captured by users G and H may be live video streams associated with the same event and either of users I, J, K may be able to join the live video streams by accessing the associated live video(s) via the page. As such, multiple users with admin rights to a common page may select to have their video streams associated together as being associated with a common (same) event.

In some example embodiments, the network device may identify one or more actions in two or more videos associated with the same event to time-align the two videos with each other. For instance, a noise (e.g., a common action) in the two videos may be identified/determined in order to align the two videos.

For purposes of illustration, and not of limitation, in the soccer game example above, the network device (e.g., network device 160) may analyze two videos and may identify for example a whistle blown by a referee. The network device may mark the two videos based on when the whistle is blown. Thereafter, the network device may be able to keep the two video streams synchronized/aligned. For example, the two videos relating to the same event of the whistle being blown in the soccer game may be 120 milliseconds (ms) apart in the two videos. The first video of the two videos may be delayed by the 120 ms as marked by the whistle. As such, the network device may know that when the second video is being played by a user that it may need to be delayed by 120 ms in order to be synchronized/aligned with the first video.

The exemplary embodiments may also facilitate an interviewer-type scenario between users of communication devices (e.g., UEs 30, client systems 130). For example, consider a situation in which at least two users such as users E and F are at a same location (e.g., a studio, an office, etc.) and are interviewing each other. In this example, both users may be looking at cameras (e.g., rear camera(s) 54, front camera(s) 56) of a communication device while dialoguing with (e.g., interviewing) each other. For instance, the two users may be sitting facing each other over an item of furniture (e.g., a desk), and the communication device may be arranged upright between the two users. The rear camera(s) (e.g., rear camera(s) 54) may be pointing at user E and capturing video content associated with user E and the front camera(s) (e.g., front camera(s) 56) may be pointing at user F and capturing video content associated with user F. In this example, consider also that the user E and the user F are looking at each other and having a natural dialogue interaction and the users E and F may be making eye contact with each other while the front camera(s) and rear camera(s) are recording the two video streams. As the two video streams are captured by the front camera(s) and the rear camera(s) respectively in real-time, the communication device may simultaneously/concurrently provide the two video streams to a network device (e.g., network device 160). In response to receiving the two video streams, the network device may arrange the two videos in a side-by-side manner and may present the two video streams to display devices (e.g., displays 42) of communication devices of users. In this manner, the two video streams may be presented on display devices and may appear as though user E and user F sat next to each other talking naturally to each other.

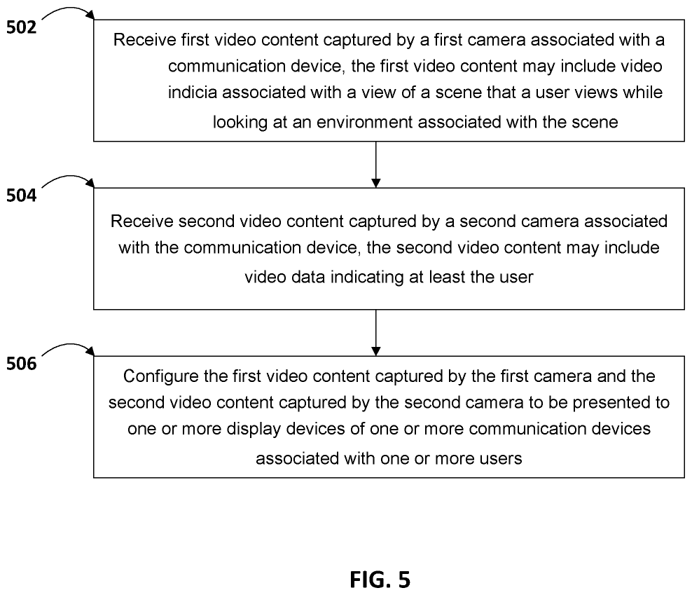

FIG. 5 illustrates an example flowchart illustrating operations for providing multiple videos captured simultaneously from different cameras to enable streaming of the multiple videos to one or more communication devices according to an exemplary embodiment. At operation 502, a device (e.g., network device 160) may receive first video content (e.g., video 410a) captured by a first camera (e.g., a front camera(s) 56) associated with a communication device (e.g., a UE 30, a client system 130). The first video content may include video indicia associated with a view of a scene that a user (e.g., a user A) views while looking at an environment associated with the scene.

At operation 504, the device (e.g., network device 160) may receive second video content (e.g., selfie video 410b) captured by a second camera (e.g., rear camera(s) 54) associated with the communication device (e.g., a UE 30, a client system 130). The second video content may include video data indicating at least the user. The first video content and the second video content may be captured simultaneously/concurrently by the first camera and the second camera, respectively. At operation 506, the device (e.g., network device 160) may configure the first video content captured by the first camera and the second video content captured by the second camera to be presented to one or more display devices (e.g., displays 42) of one or more communication devices associated with one or more users (e.g., friends of the user A within a social-networking system).

In one exemplary embodiment, configuring may include, but is not limited to, the device (e.g., network device 160) presenting the first video content and the second video content simultaneously to the one or more display devices. In another exemplary embodiment, configuring may include, but is not limited to, the device (e.g., network device 160) providing one or more control options to the one or more display devices enabling the users to select a manner in which the first video content and the second video content is to be displayed via the one or more display devices. For example, a selection of a control option(s) by a user may be to display of the first video content and the second video content side-by-side via a display device. In another example embodiment, a selection of a control option(s) by a user may be to display the first video content and the second video content in a picture-in-picture manner via a display device.

### Alternative Embodiments

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed:

1. A method comprising:
receiving first video content captured by a first camera associated with a communication device, the first video content comprises video indicia associated with a view of a scene that a user views while looking at an environment associated with the scene;
receiving second video content captured by a second camera associated with the communication device, the second video content comprises video data indicating at least the user, wherein the first video content and the second video content are captured simultaneously by the first camera and the second camera; and
configuring the first video content captured by the first camera and the second video content captured by the second camera to be presented to one or more display devices of one or more communication devices of one or more users.

2. The method of claim 1, wherein configuring comprises presenting the first video content and the second video content simultaneously to the one or more display devices.

3. The method of claim 1, wherein configuring comprises providing one or more control options to the one or more display devices enabling the one or more users to select a manner in which the first video content and the second video content is to be displayed via the one or more display devices.
